(19) United States
(12) Patent Application Publication
(10) Pub. No.: US 2001/0004810 A1
(43) Pub. Date: Jun. 28, 2001

(54) ID card-making apparatus, ID card-making method, and ID card

(76) Inventor: Michihide Tasaki, Kawaguchi-shi (JP)

Correspondence Address: Pillsbury Madison & Sutro, LLP, Ninth Floor, East Tower, 1100 New York Avenue, N.W., Washington, DC, 20005-3918, US

(21) Appl. No.: 09/741,016

(22) Filed: Dec. 21, 2000

(30) Foreign Application Priority Data
Dec. 22, 1999 (JP) 11-364570

(51) Int. Cl. G03B 27/52

(52) U.S. Cl. 40/1; 355/40; 396/2; 355/41

(57) ABSTRACT

An ID card-making apparatus provided with the following an image reading section for reading an image from a predetermined area, within which at least a photograph is present, a photograph position detection section for detecting a photograph portion from image data obtained by the image reading section, a photographic image extraction section for extracting a photographic image from the photograph portion detected by the photograph position detection section, the photographic image being extracted from an area which is inside a region defined by the photograph edge detected by the photograph position detection section and which does not include the photograph edge, and an ID card-making section for making an ID card to which the photographic image extracted by the photographic image extraction section is attached.

### CROSS-REFERENCE TO RELATED APPLICATIONS

This application is based upon and claims the benefit of priority from the prior Japanese Patent Application No. 11-364570, filed Dec. 22, 1999, the entire contents of which are incorporated herein by reference.

### BACKGROUND OF THE INVENTION

The present invention relates to an ID card with a figure image. The present invention also relates to an apparatus and a method for making such a card.

An ID card-making apparatus reads a photograph from a predetermined photograph attachment position on an ID card application form, and records or prints that photographic image on an ID card, along with the related personal information, such as the name, the address and the date of birth.

It should be noted, however, that the photograph is not necessarily attached accurately at the predetermined position. It may happen that the photograph is shifted from the predetermined position. If the photograph is read without this being considered, and the resultant image is attached to the ID card (e.g., by printing), the image may include a photograph edge or include part of a ruled line or characters on the ID card. According to the prior art ID card-making apparatus, the image on an application form is read as if it were an image slightly smaller than predetermined size, and the disadvantage described above is prevented.

The above disadvantage can be prevented by reading the image on the application form as if it were an image slightly smaller than predetermined size. In order for the image of the entire figure to be included, however, the read size cannot be reduced extremely. This means that the conventional apparatus is not useful unless a photograph is attached exactly at the right position or shifted from that right position only slightly. It should also be noted that measures for preventing forgery of ID cards are very important in recent years.

### BRIEF SUMMARY OF THE INVENTION

The present invention has been made to provide a solution to the above-mentioned disadvantage, and is intended to provide an ID card-making apparatus, an ID card-making method, and an ID card that are outlined below.

(1) An ID card-making apparatus and an ID card-making method capable of making an ID card which bears a photographic image appropriate for the certification purpose, and which is made without being adversely affected by the difference between the photograph attachment position on an application form and the actual position of a photograph and the difference between the desirable photograph size and the actual photograph size.

(2) An ID card-making apparatus and an ID card-making method capable of making an ID card that cannot be easily forged.

(3) An ID card which bears a photographic image appropriate for the certification purpose, and which is made without being adversely affected by the difference between the photograph attachment position on an application form and the actual position of a photograph and the difference between the desirable photograph size and the actual photograph size.

(4) An ID card that cannot be easily forged.

The ID card-making apparatus, ID card-making method, and ID card according to the present invention have the following features:

(1) The ID card-making apparatus of the present invention comprises: image reading means for reading an image from an area that is large enough to include a photograph of predetermined size attached to a predetermined application form; photograph position detection means for detecting a photograph edge from image data obtained by the image reading means; photographic image extraction means for extracting a photographic image from an area which is inside a region defined by the photograph edge detected by the photograph position detection means and which does not include the photograph edge; figure image extraction means for extracting a figure portion from the photographic image extracted by the photographic image extracting means; background image storage means for storing background image data; image synthesis means for producing a composite image by synthesizing the background image data stored in the background image with figure portion data extracted by the figure image extraction means; and card-making means for making an ID card to which the composite image produced by the image synthesis means is attached.

(2) The ID card-making method of the present invention comprises: an image reading step for reading an image from an area that is large enough to include a photograph of predetermined size attached to a predetermined application form; a photograph position detection step for detecting a photograph edge from image data obtained in the image reading step; a photographic image extraction step for extracting a photographic image from an area which is inside a region defined by the photograph edge detected in the photograph position detection step and which does not include the photograph edge; a figure image extraction step for extracting a figure portion from the photographic image extracted in the photographic image extracting step; an image synthesis step for producing a composite image by synthesizing background image data stored beforehand with figure portion data extracted in the figure image extraction step; and a card-making step for making an ID card to which the composite image produced in the image synthesis step is attached.

(3) The ID card of the present invention bears a composite image that is made by: reading an image from an area that is large enough to include a photograph of predetermined size attached to a predetermined application form; detecting a photograph edge from obtained image data; extracting a photographic image from an area which is inside a region defined by the detected photograph edge and which does not include the photograph edge; extracting figure portion data from the extracted photographic image; and producing a composite image by synthesizing background image data stored beforehand with the extracted figure portion data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram illustrating a schematic structure of an ID card-making apparatus according to embodiment 1 of the present invention.

FIG. 2 is a flowchart showing how an ID card is made by the ID card-making apparatus according to embodiment 1 of the present invention.

FIG. 3 is a block diagram illustrating a schematic structure of an ID card-making apparatus according to embodiment 2 of the present invention.

FIG. 4 is a flowchart showing how an ID card is made by the ID card-making apparatus according to embodiment 2 of the present invention.

FIG. 5 illustrates an image reading size used by the ID card-making apparatuses shown in FIGS. 1 and 3.

FIG. 6 shows a background image which the ID card-making apparatus of FIG. 3 attaches to an ID card, for the purpose of preventing forgery.

FIGS. 7A to 7C illustrate problems of a conventional ID card-making apparatus.

### DETAILED DESCRIPTION OF THE INVENTION

Embodiments 1 and 2 of the present invention will now be described with reference to the accompanying drawings.

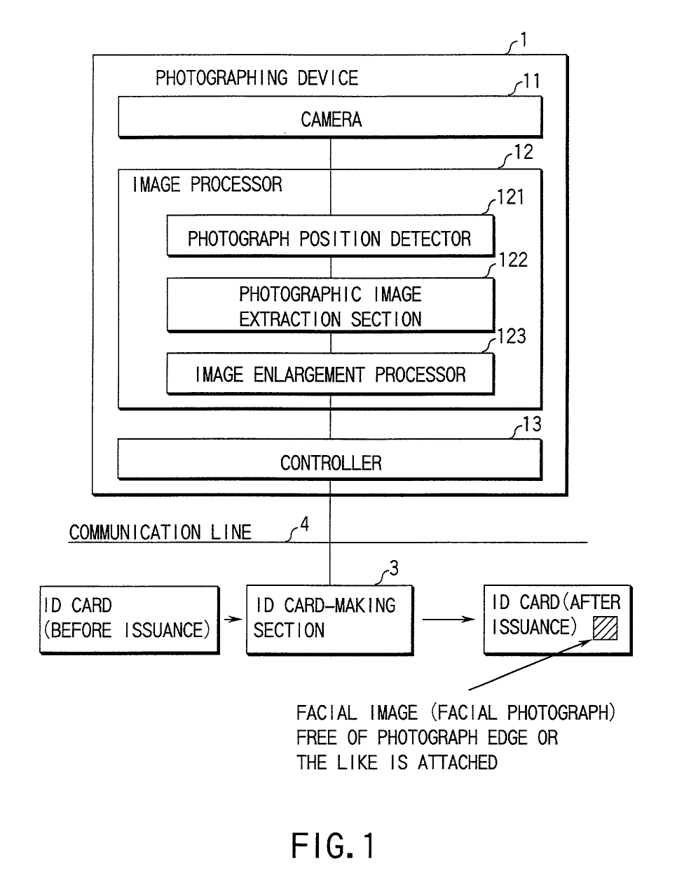

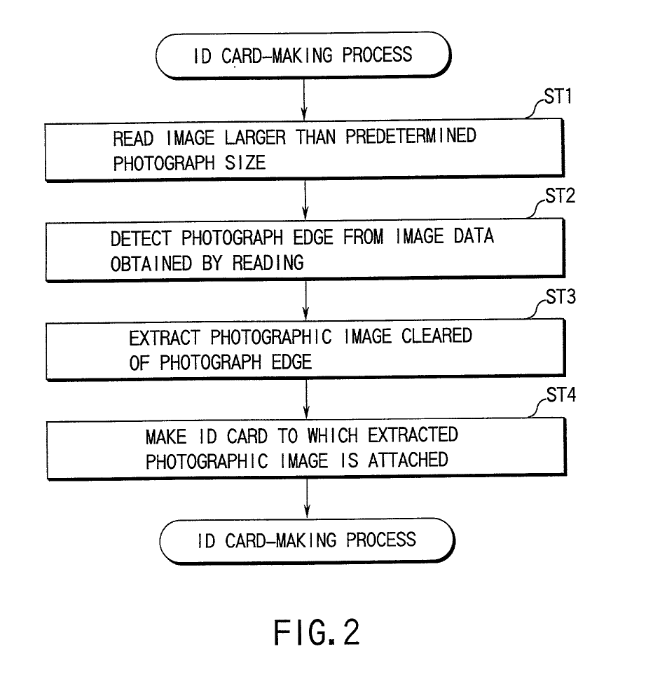

FIG. 1 is a block diagram illustrating a schematic structure of an ID card-making apparatus according to embodiment 1 of the present invention. FIG. 2 is a flowchart showing how an ID card is made by the ID card-making apparatus according to embodiment 1 of the present invention. With reference to these Figures, a description will be given of the ID card-making apparatus of embodiment 1 and of the manner in which the apparatus makes an ID card.

As shown in FIG. 1, the ID card-making apparatus of embodiment 1 comprises a photographing device 1 and an ID card-making section 3. The photographing device 1 and the ID card-making section 3 are connected to each other by means of a communication line 4.

The photographing device 1 includes a camera 11, an image processor 12 and a controller 13. The image processor 12 is made up of a photograph position detector 121, a photographic image extraction section 122 and an image enlargement processor 123.

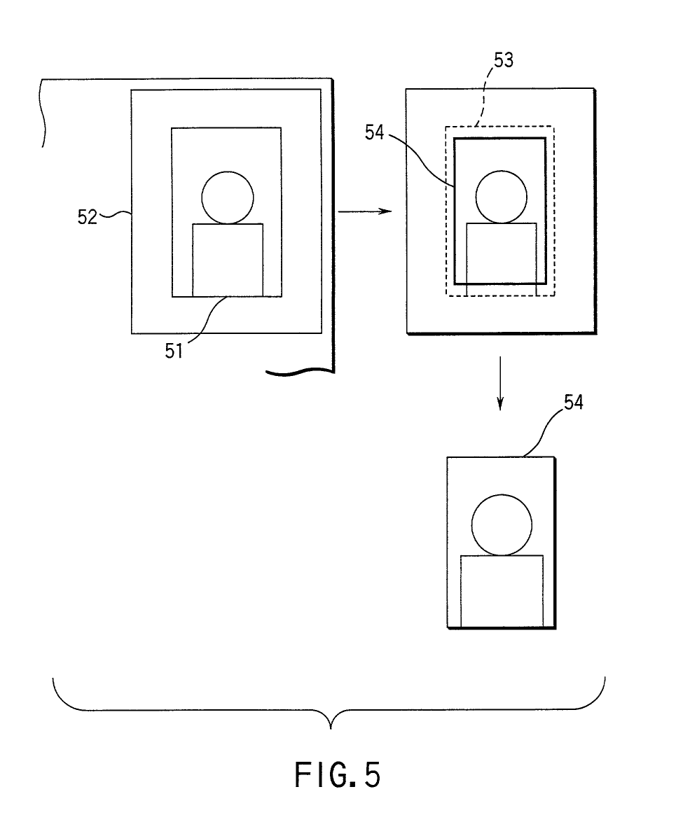

The photographing device 1 is provided with an application form processing mechanism (not shown). This application form processing mechanism receives application forms, conveys them to a predetermined area one by one, and finally discharges them from inside the photographing device 1. The camera 11 takes a picture of the photograph attached to the application forms conveyed by the application form processing mechanism, so as to obtain image data on a facial portrait. The application forms have a photograph attachment portion of predetermined size. On the basis of the position of the photograph attachment portion of an application form, the camera 11 reads an image from a certain area (Step ST1). This area is large enough to include a photograph of predetermined size attached to the application form. FIG. 5 shows how the image is read. As is clear from FIG. 5, the camera 11 reads the predetermined-size photograph 51 pasted to the photograph attachment portion on the basis of a read size 52, which is greater than the photograph 51. Step ST1 corresponds to the image reading step.

The photograph position detector 121, which serves as a photograph position detecting means, detects a photograph portion from image data obtained by the image reading operation by the camera 11. In other words, the photograph position detector 121 detects a photograph edge 53 from the image data (Step ST2). Step ST2 corresponds to the photograph position detection step. For example, the photograph position detector 121 is provided with a filter capable of detecting vertical and horizontal components of image data. By merely entering photograph size to the photograph position detector 121, the vertical and horizontal dimensions of a photograph edge can be estimated to a certain extent. To be more specific, the vertical and horizontal components detected by the filter are compared with the estimated vertical and horizontal dimensions of a photograph edge. Based on this comparison, a photograph edge can be derived from the image data. The photographic image extraction section 122, which serves as a photographic image extraction means, extracts a photographic image 54 from the image detected by the photograph position detector 121, in such a manner that the extracted photographic image 54 has such size as excludes the photograph edge 53 (Step ST3). In other words, the photographic image is extracted from inside the region defined by the detected photograph edge in such a manner that the extracted photographic image does not contain the photograph edge. Step ST3 corresponds to the photographic image extraction step. The image enlargement processor 123 enlarges the photographic image 54 extracted by the photographic image extraction section in such a way that the enlarged photographic image 54 has predetermined size.

The controller 13 controls the entire photographing device 1. For example, the controller 13 controls the operation of transferring a photographic image to the ID card-making section 3 through the communication line 4. The photographic image is either the image extracted by the photographic image extraction section 122 or the image enlarged by the image enlargement processor 123.

The ID card-making section 3 is provided with data regarding personal information to be recorded in the ID card. The data on the personal information is supplied from an external device (e.g., a keyboard) through the communications line 4. The ID card-making section 3 receives a photographic image which is transferred thereto from the photographing device by way of the communication line 4 and for which predetermined correction, such as background processing, has been executed. The ID card-making section 3 records the photographic image and the corresponding personal information on the ID card (Step ST4). Hence, the photographic image which the ID card-making section 3 attaches to the ID card is suitable for the certification purpose. To be more specific, the photographic image includes neither a photograph edge nor a ruled line or characters printed on the application form.

The above description was given, referring to the case where the photographing device 1 is provided with the image processor 12. Instead of this structure, a structural element that is equivalent in function to the image processor 12 may be provided for the ID card issuing section 3.

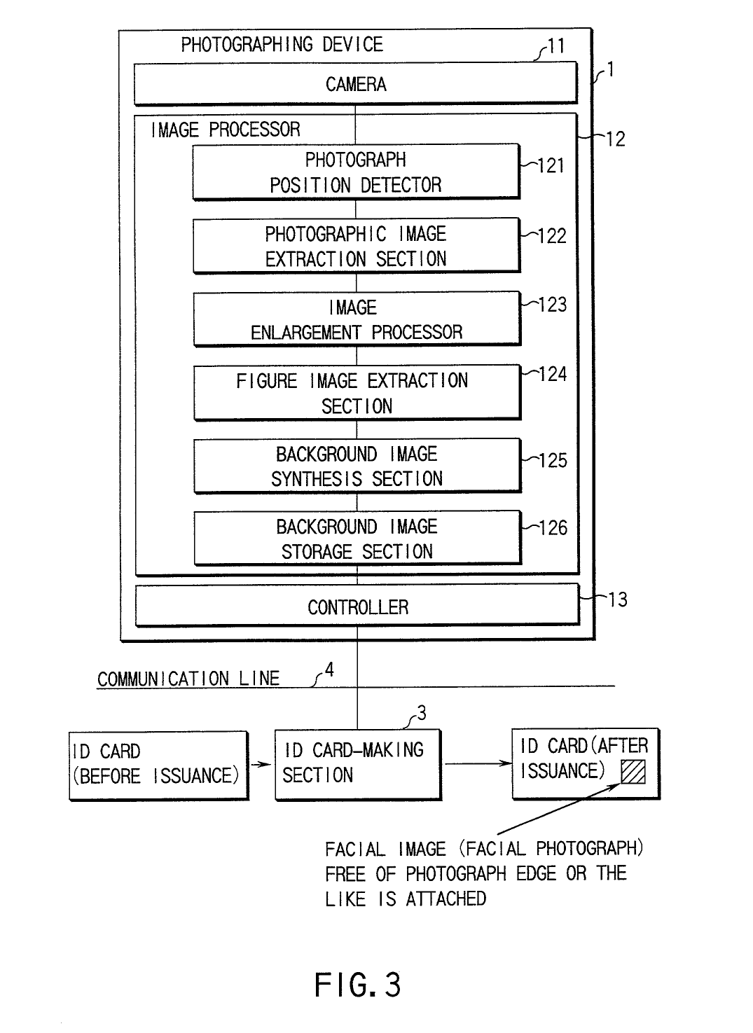

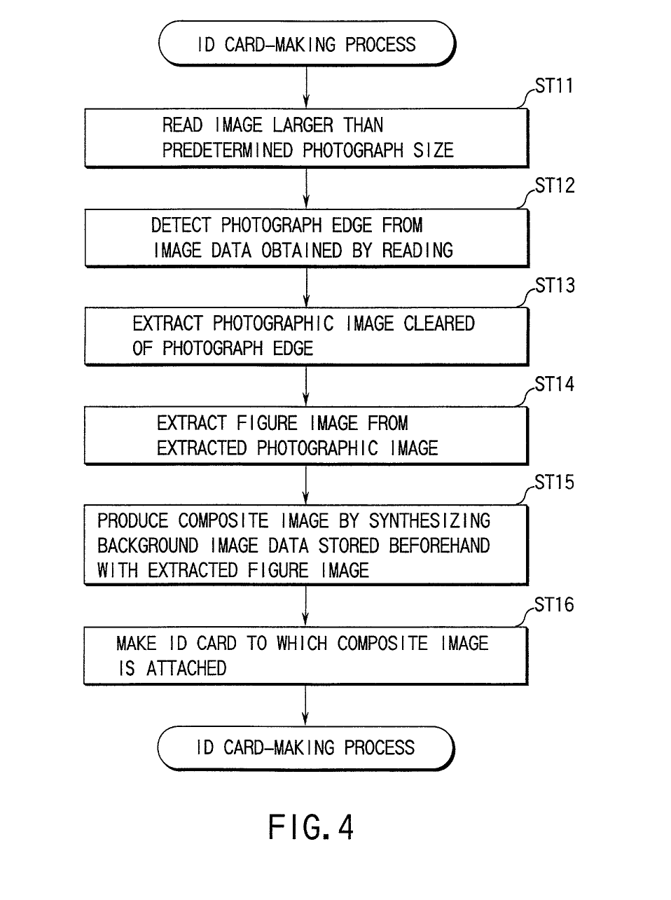

FIG. 3 is a block diagram illustrating a schematic structure of an ID card-making apparatus according to embodiment 2 of the present invention. FIG. 4 is a flowchart showing how an ID card is made by the ID card-making apparatus according to embodiment 2 of the present invention. With reference to FIGS. 3 and 4, a description will be given of the ID card making-apparatus of embodiment 2 and of the manner in which the apparatus makes a card.

As shown in FIG. 3, the ID card-making apparatus of embodiment 2 of the present invention is provided with a photographing device 1 and an ID card-making section 3. The photographing device 1 and the ID card-making section are connected together by means of a communication line 4. Of the structural components of the apparatus of embodiment 2, those which are similar to the structural components of the apparatus of embodiment 1 will be described in a simplified manner, or reference to such structural components will be omitted.

The photographing device 1 is provided with a camera 11, an image processor 12 and a controller 13. The image processor 12 includes a photograph position detector 121, a photographic image extraction section 122, an image enlargement processor 123, a figure image extraction section 124, a background image synthesis section 125, and a background image storage section 126.

The photographing device 1 is provided with an application form processing mechanism (not shown). This application form processing mechanism is similar to the one described in relation to embodiment 1. The camera 11 takes a picture of the photograph attached to an application form conveyed by the application form processing mechanism, so as to obtain image data on a facial portrait. On the basis of the position of the photograph attachment portion of an application form, the camera 11 reads an image from a certain area (Step ST11). This area is large enough to include a photograph of predetermined size attached to the photograph attachment portion. The read size of the camera 11 is determined in the same manner as described in relation to embodiment 1. Step ST11 corresponds to the image reading step.

The photograph position detector 121, which serves as a photograph position detecting means, detects a photograph portion from image data obtained by the image reading operation by the camera 11. In other words, the photograph position detector 121 detects a photograph edge 53 from the image data (Step ST12). Step ST12 corresponds to the photograph position detection step. For example, the photograph position detector 121 is provided with a filter capable of detecting vertical and horizontal components of image data. By merely entering photograph size to the photograph position detector 121, the vertical and horizontal dimensions of a photograph edge can be estimated to a certain extent. To be more specific, the vertical and horizontal components detected by the filter are compared with the estimated vertical and horizontal dimensions of a photograph edge. Based on this comparison, a photograph edge can be derived from the image data. The photographic image extraction section 122, which serves as a photographic image extraction means, extracts a photographic image 54 from the image detected by the photograph position detector 121, in such a manner that the extracted photographic image 54 has such size as excludes the photograph edge 53 (Step ST13). In other words, the photographic image is extracted from inside the region defined by the detected photograph edge in such a manner that the extracted photographic image does not contain the photograph edge. Step ST13 corresponds to the photographic image extraction step. The image enlargement processor 123 enlarges the photographic image 54 extracted by the photographic image extraction section 122 in such a way that the enlarged photographic image 54 has predetermined size.

The figure image extraction section 124, which serves as a figure image extraction means, extracts a figure-image portion (e.g., an image of the upper half body of a person, an image of the face of the person, or the like) from the edge-removed photographic image (e.g., a photographic image which is enlarged and from which the edge is removed) (Step ST14). In other words, only the figure portion is extracted from the edge-removed photographic image by cutting out the background image. For this extraction, figure edge detection or contrast detection may be used. This step corresponds to a figure image extraction step. The background image storage section 126, which serves as a background image storage means, stores a predetermined background image (e.g., a blue background). The background image synthesis section 125, which serves as an image synthesis means, synthesizes a figure image extracted by the figure image extraction section 124 with the background image data stored in the background image storage section 126, thereby producing a composite image (Step ST15). This step corresponds to the image synthesis step. The controller 13 controls the entire photographing device 1. For example, the controller 13 controls the operation of transferring the composite image, made by the figure image synthesis section 125, to the ID card-making section 3 through the communication line 4.

The ID card-making section 3 is provided with data regarding personal information to be recorded in the ID card. The ID card-making section 3 records the composite image (which is supplied thereto from the photographing device 1 through the communication line 4) and the corresponding personal information data on the ID card (step ST16). Hence, the photographic image which the ID card-making section 3 attaches to the ID card is suitable for the certification purpose. To be more specific, the photographic image includes neither a photograph edge nor a ruled line or characters printed on the application form.

The above description was given, referring to the case where the photographing device 1 is provided with the image processor 12. Instead of this structure, a structural element that is equivalent in function to the image processor 12 may be provided for the ID card issuing section 3.

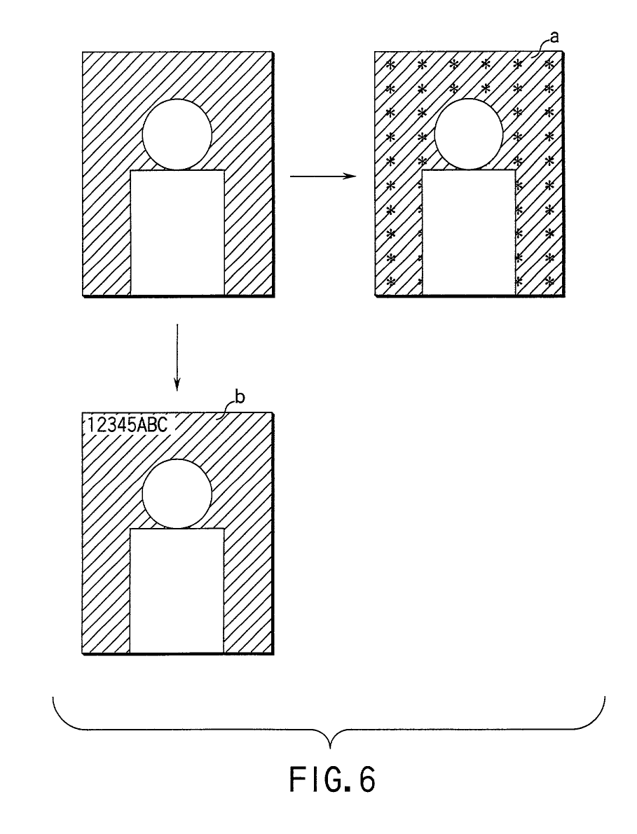

A description will now be given as to how forgery is prevented by using the background image. In the above description, reference was made to the case where the background image storage section 126 stores a predetermined background image. If this background image is image a or b shown in FIG. 6, the forgery of the ID card can be prevented.

As shown in FIG. 6, background image a has a number of embedded patterns. The embedded pattern is, for example, the logo of the company that issues the ID card. Background image b has an embedded ID code used for forgery prevention. An image having such a forgery-preventing background image can be attached to a card by employing an ID card issuing apparatus of the present invention.

A description will now be given of the problems of the conventional ID card-making apparatus and of the advantages of the ID card-making apparatus of the present invention.

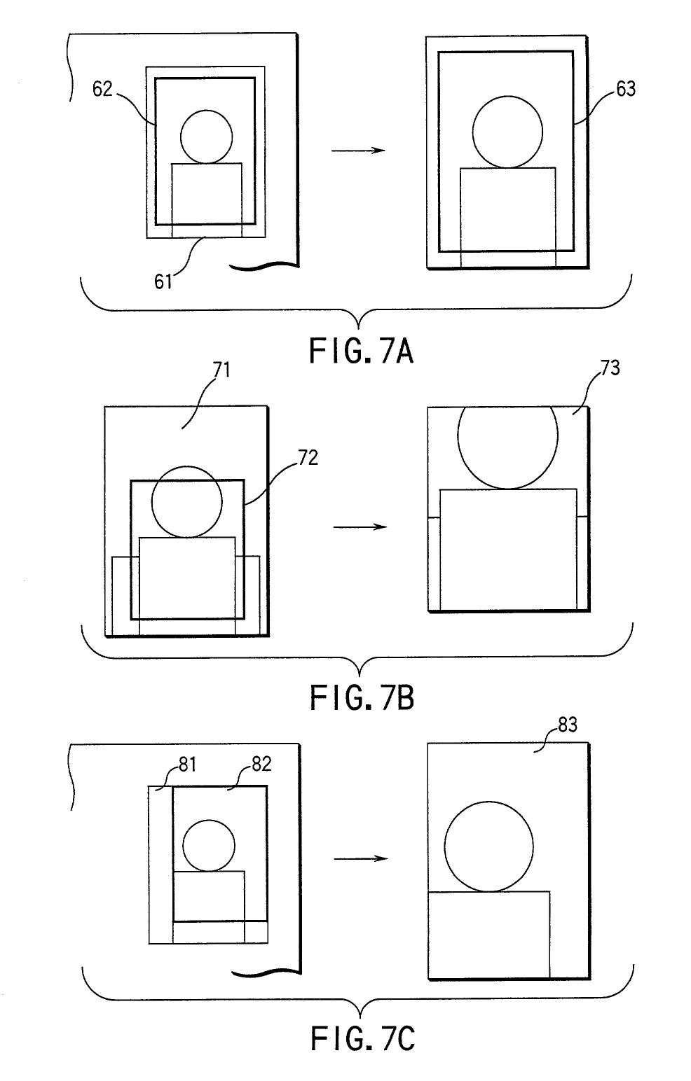

According to the ID card-making apparatus of the prior art, the photograph 61 attached to the application form is read by use of a read size 62 that is slightly smaller than the photograph 61, as shown in FIG. 7A. By reading the photograph in this manner, the resultant photographic image 63 is suitable for the certification purpose.

If a large-sized photograph 71, which is larger than the predetermined size, is attached to the application form, as shown in FIG. 7B, it should not be read in the above manner. If it is read in that manner, the resultant photographic image 73 may be inappropriate for the certification purpose. For example, part of the figure image (e.g., the image of the top of the head) may be missing though it is included in the photograph 71 attached to the application form.

In the conventional ID card-making apparatus, the read position of the camera is just in front of the photograph attachment portion of the application form. If a photograph is attached at a position shifted from the right position, it should not be read based on the read size 82 described above. If it is read in the manner shown in FIG. 7C, what the resultant photographic image 83 shows is shifted from the center of the original image and is therefore inappropriate for the certification purpose.

The ID card-making apparatus of the present invention reads an image by use of a read size greater than a predetermined size, detects a photograph edge from the image data obtained by reading the image, extracts a photographic image that does not include the detected photograph edge, and processes the extracted photographic image as a photograph used for certification. Accordingly, the ID card-making apparatus of the present invention solves the problems of the conventional apparatus.

According to the present invention, it is possible provide an ID card-making apparatus, an ID card-making method, and an ID card that are outlined below.

(1) An ID card-making apparatus and an ID card-making method capable of making an ID card which bears a photographic image appropriate for the certification purpose, and which is made without being adversely affected by the difference between the photograph attachment position on an application form and the actual position of a photograph and the difference between the desirable photograph size and the actual photograph size.

(2) An ID card-making apparatus and an ID card-making method capable of making an ID card that cannot be easily forged.

(3) An ID card which bears a photographic image appropriate for the certification purpose, and which is made without being adversely affected by the difference between the photograph attachment position on an application form and the actual position of a photograph and the difference between the desirable photograph size and the actual photograph size.

(4) An ID card that cannot be easily forged.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An ID card-making apparatus comprising card-making means for detecting a photograph portion from image data, extracting a target image from the detected photograph portion, and making an ID card based on the target image.

2. An ID card-making apparatus according to claim 1, further comprising:
image reading means for reading an image from a predetermined area, within which at least a photograph is present;
photograph position detection means for detecting a photograph portion from image data obtained by the image reading means;
photographic image extraction means for extracting a photographic image from the photograph portion detected by the photograph position detection means, said photographic image being extracted from an area which is inside a region defined by the photograph edge detected by the photograph position detection means and which excludes the photograph edge; and
ID card-making means for making an ID card to which the photographic image extracted by the photographic image extraction means.

3. An ID card-making apparatus according to claim 1, further comprising:
image reading means for reading an image from an area that is large enough to include a photograph of predetermined size attached to a predetermined application form;
photograph position detection means for detecting a photograph edge from image data obtained by the image reading means;
photographic image extraction means for extracting a photographic image from an area which is inside a region defined by the photograph edge detected by the photograph position detection means and which excludes the photograph edge; and
ID card-making means for making an ID card to which the photographic image extracted by the photographic image extraction means is attached.

4. An ID card-making apparatus according to claim 1, further comprising:
image reading means for reading an image from an area that is large enough to include a photograph of predetermined size attached to a predetermined application form;
photograph position detection means for detecting a photograph edge from image data obtained by the image reading means;
photographic image extraction means for extracting a photographic image from an area which is inside a region defined by the photograph edge detected by the photograph position detection means and which excludes the photograph edge;
figure image extraction means for extracting a figure portion from the photographic image extracted by the photographic image extracting means;
background image storage means for storing background image data;
image synthesis means for producing a composite image by synthesizing the background image data stored in the background image storage means with figure portion data extracted by the figure image extraction means; and
card-making means for making an ID card to which the composite image produced by the image synthesis means is attached.

5. An ID card-making apparatus according to claim 4, wherein said background image storage means includes a storage section for storing background image data into which forgery preventing data is inserted.

6. An ID card-making apparatus according to claim 4, wherein said background image storage means includes a storage section for storing at least one of: background image data into which an ID code for forgery prevention is inserted; and background image data into which a plurality of predetermined marks for forgery prevention are inserted.

7. An ID card-making method comprising the steps for detecting a photograph portion from image data, extracting a target image from the detected photograph portion, and making an ID card based on the target image.

8. An ID card-making method according to claim 7, further comprising:
an image reading step for reading an image from an area that is large enough to include a photograph of predetermined size attached to a predetermined application form;
a photograph position detection step for detecting a photograph edge from image data obtained in the image reading step;
a photographic image extraction step for extracting a photographic image from an area which is inside a region defined by the photograph edge detected in the photograph position detection step and which excludes the photograph edge; and
a card-making step for making an ID card to which the photographic image extracted in the photographic image extraction step is attached.

9. An ID card-making method according to claim 7, further comprising:
an image reading step for reading an image from an area that is large enough to include a photograph of predetermined size attached to a predetermined application form;
a photograph position detection step for detecting a photograph edge from image data obtained in the image reading step;
a photographic image extraction step for extracting a photographic image from an area which is inside a region defined by the photograph edge detected in the photograph position detection step and which excludes the photograph edge;
a figure image extraction step for extracting a figure portion from the photographic image extracted in the photographic image extracting step;
an image synthesis step for producing a composite image by synthesizing background image data stored beforehand with figure portion data extracted in the figure image extraction step; and
a card-making step for making an ID card to which the composite image produced in the image synthesis step is attached.

10. An ID card-making method according to claim 9, wherein said image synthesis step synthesizes the background image data, into which forgery prevention data is inserted, with the figure portion data extracted in the figure image extraction step.

11. An ID card which is made by detecting a photograph portion from image data, extracting a target image from the photograph portion, and using the target image.

12. An ID card according to claim 11, comprising a photographic image attached thereto, said photographic image being made by reading an image from an area that is large enough to include a photograph graph of predetermined size attached to a predetermined application form; detecting a photograph edge from obtained image data; and extracting a photographic image from an area which is inside a region defined by the detected photograph edge and which excludes the photograph edge; and using the extracted photograph.

13. An ID card according to claim 11, comprising a composite image that is made by: reading an image from an area that is large enough to include a photograph of predetermined size attached to a predetermined application form; detecting a photograph edge from obtained image data; extracting a photographic image from an area which is inside a region defined by the detected photograph edge and which excludes the photograph edge; extracting figure portion data from the extracted photographic image; and producing a composite image by synthesizing background image data stored beforehand with the extracted figure portion data.

14. An ID card according to claim 13, wherein said background image data includes forgery prevention data.
